(19) United States
(12) Patent Application Publication
(10) Pub. No.: US 2019/0233122 A1
(43) Pub. Date: Aug. 1, 2019

(54) THERMOPLASTIC TRAY TABLE WITH COMPLIANT FRICTION DEVICES FOR NON-SLIP OPERATION

(71) Applicant: Reliant Worldwide Plastics, LLC, Plano, TX (US)

(72) Inventor: William Maslakow, Plano, TX (US)

(21) Appl. No.: 16/258,324

(22) Filed: Jan. 25, 2019

Related U.S. Application Data
(60) Provisional application No. 62/622,495, filed on Jan. 26, 2018.

(51) Int. Cl. B64D 11/06

(52) U.S. Cl. CPC B64D 11/0638; B60N 3/004

(57) ABSTRACT

A tray table which includes a top cover coupled to a bottom cover. The top cover has a recess and at least one aperture which extends completely through the top cover. A non-slip device is coupled to the recess via a variety of methods, including injection. The non-slip device prevents items from sliding along the top cover.

### PRIORITY

The present invention claims priority to Provisional Application No. 62/622,495 filed on Jan. 26, 2018, the entirety of which is hereby incorporated by reference in its entirety.

### BACKGROUND OF THE INVENTION

### Technical Field

The present invention relates generally to commercial aircraft passenger food tray tables and more particular, but not by way of limitation, to a thermoplastic tray table with integral compliant friction devices providing a non-slip surface for use during the operation of the aircraft.

### Description of Related Art

Conventional tray tables are used to balance and hold a variety of items during flight. However, there is typically nothing which prevents these items from sliding during flight. Consequently, there is a need for an improved non-slip operation.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the thermoplastic tray table with integral compliant friction devices for non-slip operation in one embodiment;

FIG. 2 is an enlarged cut-away perspective view of tray table in one embodiment;

FIG. 2A is an enlarged cut-away perspective view of integral recess detail of tray table in one embodiment;

FIG. 3 is an enlarged cut-away perspective internal view of the top cover in one embodiment;

FIG. 3A is an enlarged cut-away perspective internal view of resin runner detail of a tray table in one embodiment;

FIG. 4 is a cut-away perspective view of a tray table top cover friction device injection mold in one embodiment;

FIG. 4A is an enlarged cut-away perspective view detail of a tray table top cover friction device injection mold in one embodiment;

FIG. 4B is an enlarged cut-away side view of detail of a tray table top cover integral compliant friction device injection mold in one embodiment;

FIG. 5 is a perspective view of a tray table in a down position in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

In one embodiment a Thermoplastic Tray Table assembly is disclosed which is utilized in commercial aircraft passenger cabins with a plurality of injection molded Non-Slip Friction Devices integral to the tray table cover surface. The integral non-slip friction devices are compliant and provide a restriction-to-movement mechanism to items placed upon at least a portion of the non-slip friction devices. One advantage to this solution is that items may be placed on the tray table and will not slip due to the non-slip friction devices. Thus, the user does not have to worry about the items sliding on the tray table. Another advantage, discussed in more detail below, is that the non-slip friction devices have a low profile which reduces the likelihood that they will be intentionally, or unintentionally, damaged or removed by a passenger.

As will be discussed in more detail below, the integral non-slip friction devices are compliant by material type and durometer such that they deflect or displace upon the application of weight or normal force derived from items placed upon said non-slip friction devices. The product of frictional force (Ff) of the non-slip friction devices and the weight or normal force (Fn) of the passenger item creates a Coefficient of Kinetic Friction (μ) greater than 0 and in some cases greater than 1. In one embodiment the use of an elastomeric non-slip device will alter the coefficient of friction by greater than 50% and the dynamic movement will be restricted. The frictional force restricts the movement of the items placed upon the non-slip friction devices until such time the passenger physically removes or relocates the item. In one embodiment the range for the tray material when interfacing a metal object is 0.3-0.7, expressed as coefficient of dynamic friction. In one embodiment the range for the non-slip material when interfacing a metal object is 0.6-1.0, expressed as coefficient of dynamic friction.

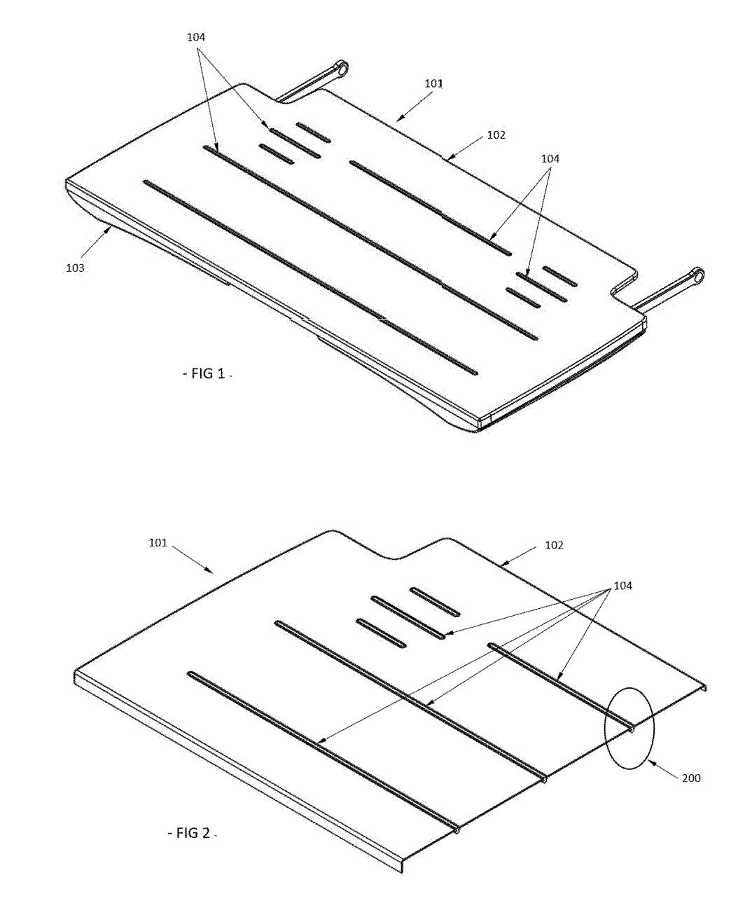

Turning now to the figures where similar items share similar reference numbers. Turning to FIG. 1, FIG. 1 is a perspective view of the thermoplastic tray table with integral compliant friction devices for non-slip operation in one embodiment. While a tray table 101 will be described, this is for illustrative purposes only and should not be deemed limiting. The non-slip properties of the system and method discussed herein can be applied to virtually any planar surface which the user desires to have non-slip properties.

A thermoplastic tray table, typically utilized in the commercial aerospace industry, as an example, has a thermoplastic top cover 102 and a thermoplastic bottom cover 103. These covers are affixed to an internal injection molded thermoplastic frame structure.

The top 102 and bottom 103 covers, in one embodiment, are located in substantially parallel opposing planes. In one embodiment the top 102 and bottom 103 covers comprise a textured, as extruded surface condition, which would be the passenger facing surface. In one such embodiment, the inner opposing surfaces are typically not textured. This is for illustrative purposes only and should not be deemed limiting. As an example, in one embodiment the top 102 and bottom 103 covers comprise a non-textured surface condition. In one embodiment the top cover 102 is the cover which will hold and support an item when the tray table 101 is down. When the tray table is down, the bottom cover 103 is facing a passenger's legs.

As depicted, the top 102 and bottom 103 include one integral application specific recess and through aperture features. In one embodiment such features are created during thermoforming or injection molding process or the trimming operation of the covers. As discussed, these recesses are configured to accept at least one non-slip friction device 104. In one embodiment the non-slip friction device 104 is injection molded and integrated into the formed recess feature of the tray table during an injection molding process.

The number and location of the non-slip device 104 can alter depending upon the application. In one embodiment the non-slip device 104 is located on the top cover 102. The non-slip device 104 can comprise a linear shape as depicted in FIG. 1, but this is for illustrative purposes only and should not be deemed limiting. The non-slip device 104 can comprise non-linear shapes as well. As depicted the non-slip device 104 is located where a passenger typically places a drink, such as the upper right or left corner of the top cover 102. This helps prevent the drink item, as an example, from sliding downward off the tray table 101. As noted, when an item encounters the non-slip device 104, further slipping or sliding is reduced or prevented by the non-slip device 104. Such a benefit can reduce slipping without compromising the structural integrity of the tray table 101. By reducing sliding of items on a tray table 101, safety of passengers is increased. Further, there will be fewer incidents of spills during flights and less time required to clean between flights as a result of the decreased spills. Likewise, there will be fewer vouches for dry cleaning or complimentary items to defuse passenger spill situations. Taken further, operators can eliminate the use of expensive cloth tray table coverings in Business and First Class. This results in cost savings from the cloth, as well as reduced time to tend to, replace, and replace the cloth. With the non-slip device 104 described herein, passengers need not be concerned with food or drinks slipping and falling into their laps. However, the non-slip device 104 does not prevent a user from manually moving the item. A gentle force allows the item to be moved over the non-slip device 104 to a new position.

The size and location of the non-slip device 104 can be altered for any application. The non-slip device 104 can be integrated into a logo or slogan. Further, the non-slip device 104 can comprise virtually any color or colors. Cabin color harmony can be created by matching the barriers with other components within the passenger cabin area as well. Multiple colors can be used to enhance the visual impact of the non-slip device 104. Further, because the non-slip device 104 inlay can be created with virtually any design or color, Airline operators can utilize the tray table as a marketing canvass.

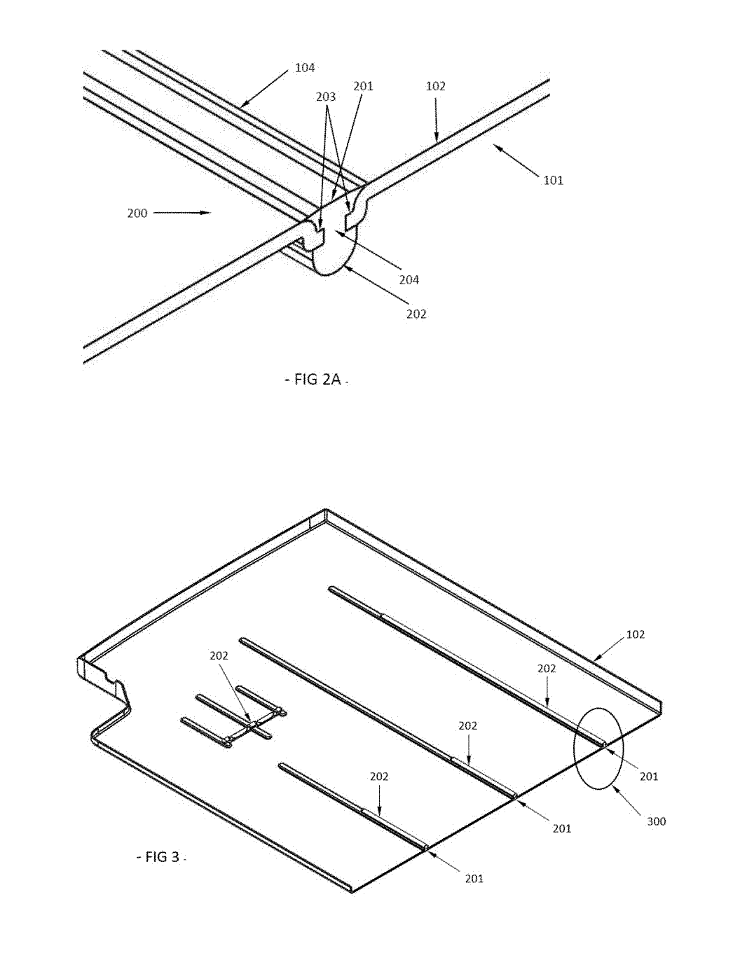

FIG. 2 is an enlarged cut-away perspective view of tray table in one embodiment. As can be seen, a plurality of non-slip friction devices 104 are formed within a recess of the tray table 101.

FIG. 2A is an enlarged cut-away perspective view of integral recess detail of tray table in one embodiment. As depicted, the non-slip device 104 is located on the top cover 102 such that the top portion of the non-slip device 104 is visible to a passenger. The recess 203 is a dip or channel which is located on top surface of the top cover 102. In one embodiment the depth of the recess 203 ranges from about 0.03 to about 0.07 inches. In some embodiments depths less than 0.03 inches may encounter fill issues during the injection molding process. In still other embodiments, depths greater than 0.07 can induce shrink deviation warpage or introduce additional unwanted weight created by the excess material weight of the non-slip device 104 and the hidden elements 202. This depth does not include the “V” raised center feature which would add an additional 0.005-0.01 inches. In one embodiment, the recess 203 extends for the length of the non-slip friction device 104. The recess 203 is configured to accept and receive at least one no-slip friction device 104. In one embodiment the recesses comprise a bottom surface, a first and second side surface substantially vertically perpendicular to the bottom surface, and first and second end surfaces substantially vertically perpendicular to the bottom surface. The recess 203, in one embodiment, comprises channels within the tray 100 into which the non-slip friction devices 104 can be poured, injected, or otherwise attached.

The sides and ends of the recesses can comprise a tapered vertical surface, as depicted. In one embodiment they can include a draft of a draft of 0.5° to 5.0° from vertical for injection molding purposes, for example. The recesses can further comprise radii or fillet corners connected the top surface of the tray cover to the substantially vertically perpendicular side and end surfaces. The radii or fillet corners can be thermoform of injection mold process inherent.

A theoretical sharp corner (TSC) point can be established where the cover top surface plane intersects the substantially vertically perpendicular side or end surface plane. A distinct opposing point can then be established. An imaginary line can then be disposed connecting said points across the width of the open top region of said recess. The disposed line establishes a plane that is equivalent flush to the top surface of the tray cover.

As shown, the recess 203 is fluidly coupled to at least one aperture 204. As shown in FIG. 2A, the top cover 102 comprises an aperture 204. As can be seen, in one embodiment, the aperture 204 extends completely through the top cover 102. Thus, the aperture 204 is a hole into which the non-slip friction device 104 can be inserted, injected, etc. Depending upon the geometry of the recess 203, there may be one or a plurality of apertures 204. The quantity and pitch spacing of the apertures 204 can be adjusted depending upon the desired application.

The apertures 204 can have virtually any cross-sectional shape. In some embodiments the apertures 204 comprise a circular shape. In still other applications, the apertures 204 can include non-circular geometries such as an ellipse or radii corner square or rectangle, for example. The apertures 204 act as a conduit connected the top side of the top cover 102 to the bottom side of the top cover 102.

The non-slip friction device 104 can be inserted or coupled via any method known in the art. In one embodiment they are injection molded mate-able to the tray table, and specifically to the recess 203. In one such embodiment a thermoformed or injection molded and finish trimmed tray cover is installed into an application specific injection mold tool. The passenger facing textured outside surface of the tray table is placed into a mold tool recess, and the textured surface is intimate to the mold tool and not exposed. The non-textured inner surface is exposed.

In one embodiment the apertures 204 of the formed recesses 203 are exposed. The mold tool can be configured to align the apertures 204 with a geometrically configured resin runner recess. At the initiation of the injection molding cycle, the injection mold tool will close upon the installed tray cover. Thereafter, a subsequent clamping cycle is completed.

In one embodiment the apertures 204 are fully captured by a runner system 202. The runner system creates a connection channel to each aperture to ensure they are fluidly connected with one another. In one embodiment multiple non-slip friction device 104 segments can be captured by an independent runner system, or an extension of an adjacent runner system. In one embodiment, all apertures 204 for a given application or geometry will be captured by a material runner system.

In one embodiment, during formation of the non-slip friction device 104, a resin injection nozzle or gate is aligned with the runner system. When the mold tool and the runner system are aligned, upon introduction of the resin material, the material fills the runner system. Upon reaching capacity with the runner system, the material continues to flow through each aperture 204. The material continues to flow through each aperture and subsequently fills the recesses 203 of the tray cover. The resulting non-slip friction device 104 will mimic the geometry configuration of the injection mold tool and top surface of the non-slip friction device 104 geometry.

After a suitable curing cycle, the injection mold tool opens to expose the tray table cover. The runner system 202 will remain on the tray cover. Because the runner system 202 is connected to the apertures 204 and the non-slip friction device 104, a redundant retention system is created.

The portion of the non-slip friction device 104 located above the top cover 103 is referred to as an exposed side. The portion of the non-slip friction device 104 located below the top cover 103 is referred to as a hidden side. It should be noted that even if the portion below the top cover 103 is visible to the user, herein it is still referred to as hidden because it is often hidden if covered by a bottom side.

As shown, the top portion of the non-slip friction device 104 is on the top side of the top cover 102. Thus, in one embodiment, the top portion of the non-slip friction device 104 is outwardly facing and is visible to the passenger. As shown, the top portion of the non-slip friction device 104 comprises an inverted V-shape. The portion which is adjacent to the top cover 103, the exposed side, has a larger width. As depicted, the edges of the exposed side are substantially flush with the adjacent planar surface of the top cover 103. However, the center of the exposed side of the non-slip friction device 104 comprises a slightly raised region. Such a shape results in a raised portion 201 to restrict movement of an item. While a V-shape has been shown and discussed, this is for illustrative purposes only and should not be deemed limiting. A benefit of the V-shape, or other similar shape, is a gradual increase to an inflection or raised point. This draws less attention to the non-slip device 104 and reduces the likelihood that it can be damaged by a passenger. In other applications, however, it may be beneficial to have a steep an aggressive incline.

As noted, the size of the raised portion 201 can be adjusted depending on the application. In one embodiment the raised portion 201 is raised about 0.005 inches above the planar surface of the top cover 103. In one embodiment the raised portion 201 is raised between about 0.001 and 0.005 inches above the planar surface of the top cover 103.

In one embodiment the exposed side of the non-slip friction device comprises a length, and the hidden side of the non-slip friction device comprises a length, and the lengths are approximately the same length. Thus, in one embodiment, the runner 202, also referred to as the hidden side, runs along and below the exposed side.

The width of the exposed side can vary. As noted, in one embodiment the exposed side has an inverted V-shape which includes a raised portion 201 which is the maximum height. Thus, in one embodiment, both sides of the width extend upward to the raised portion 201. As noted, in one embodiment the exposed side extends about 0.005 inches above the adjacent planar surface of the top cover.

The greater the width, the greater the gripping ability of the non-slip 104. In one embodiment the width of the exposed side varies from about 0.06-0.1 inches. In one embodiment the width is approximately 0.03 inches per side greater than the width of recess 203.

The dimensions of the hidden side can also vary. In one embodiment the hidden side has a maximum diameter, and the aperture 204 comprises a diameter. In one embodiment the diameter of the hidden side is greater than the diameter of the aperture 204. This helps lock the non-slip 104 in its desired location.

In one embodiment the width of the hidden element, the runner 202 ranges from about 0.036-0.09 inches in width. Retention provided by the runner 202 is adequate at 0.036 inches without introducing additional weight to the assembly.

It should be noted that the runner 202 have the advantage of improving retention of the non-slip devices 104. The runner 202 also creates a warpage counterbalance. The material of the runner 202 will shrink at near or at the same rate as the exposed non-slip devices 104. So the shrinkage of non-slip device 104 across the exposed top surface of the tray table and the shrinkage of the runner 102 on the opposing non-exposed side of the tray table is balanced and creates resistance to warping the tray cover. In one embodiment, if the runner 102 were less than 50% volume of the exposed non-slip devices 104, then the non-slip devices 104 would shrink greater and would pull the top surface of the tray inward due to the greater shrinkage level of the exposed non-slip device 104. Adequate volume of the runner 102 is needed not only to create retention but to create a counter acting shrinkage on the opposite side of the tray cover so it remains relatively flat after the non-slip devices are integrated.

In one embodiment the diameter of the aperture 204 from the non-slip device 104 to the runner 102 can range from 0.03-0.065 inches. The diameter of the runner 102 ranges from about 0.036 to 0.09 inches.

In one embodiment the diameter of the runner 202 is greater than the diameter of the aperture 204 to ensure proper integrity of the connection points to the aperture 204 to the runner 202 and the non-slip devices 104.

When a user places an item on the top cover 103, the weight or normal force of the item will deflect or displace the elevated region 201 of the non-slip friction device 104. The opposing force created by the mechanical properties and characteristics of the non-slip friction device 104 during deflection of displacement creates an adequate amount of frictional force which is applied to restrict movement of the item. Thus, the raised portion 201 of the non-slip friction device 104 prevents the item from slipping or otherwise sliding down the top cover 103.

As noted, in one embodiment the non-slip friction device 104 has a low profile relative to the adjacent planar surface of the top cover 102. This is an advantage because it provides the non-stick qualities desired, but yet it is not easily manipulated or removed by a user. If the non-slip friction device 104 had a high profile, then a user, bored on a long flight, would be more likely to tear and rip at the non-slip friction device 104. The non-slip friction device 104 cannot function as intended if it is removed. Consequently, having a non-slip friction device 104 which is difficult to damage or remove is beneficial.

The non-slip friction device 104 can comprise virtually any material which increases friction for an item sitting on the top cover 102. In one embodiment the non-slip friction device 104 comprises a flexible thermoplastic material, such as Thermoplastic Elastomers (TPE) and Thermoplastic Urethane (TPU), Thermoset Elastomers such as liquid silicone rubber, and others. These examples are provided for illustrative purposes only and should not be deemed limiting. The deflection or displacement of the elevated top surface of the non-slip friction device is a function of the material hardness or durometer. In one embodiment the non-slip friction device 104 is flexible at room temperatures.

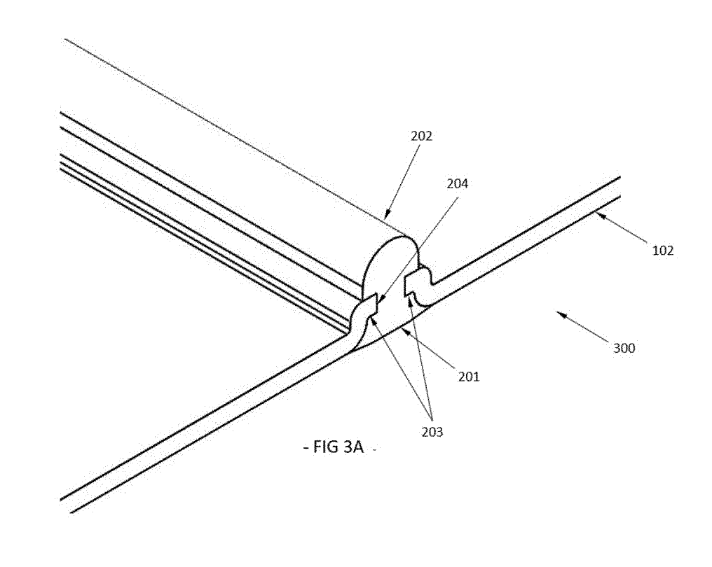

Turning now to FIG. 3, FIG. 3 is an enlarged cut-away perspective internal view of the top cover in one embodiment. As can be seen, the raised portion 201 is located atop the top cover 102 whereas the runner 202 is located below the top cover 102. In this manner, and in the depicted embodiment, the runner 202 is hidden from view. Further, as discussed above, because the runner 202 is hidden from view, it is also not susceptible to damage or removal by a user, either intentionally or accidentally. FIG. 3 also shows details of apertures 204 and where they can be located.

FIG. 3A is an enlarged cut-away perspective internal view of resin runner detail of a tray table in one embodiment. The runner 202 is located on top of the figure. As can be seen, the non-slip friction device 104 top (that which is located atop and adjacent to the top cover 102) has a slow profile which is flush with the top cover 102 and the recess 203.

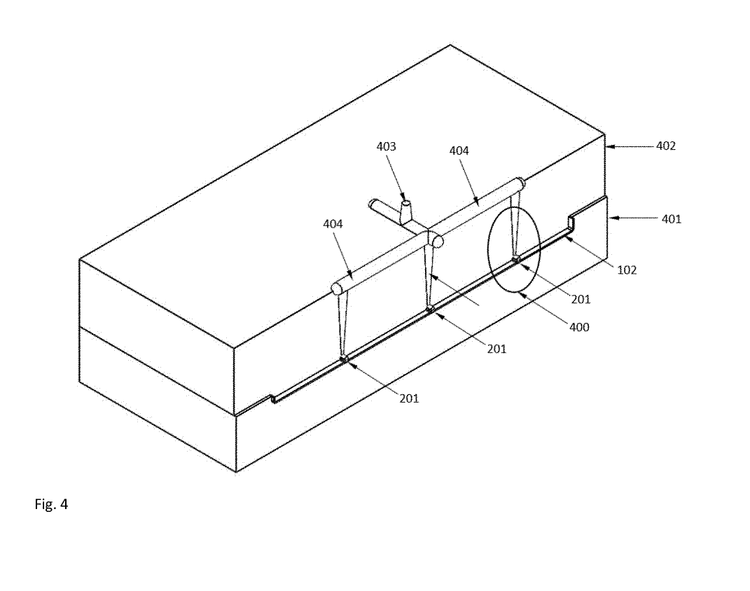

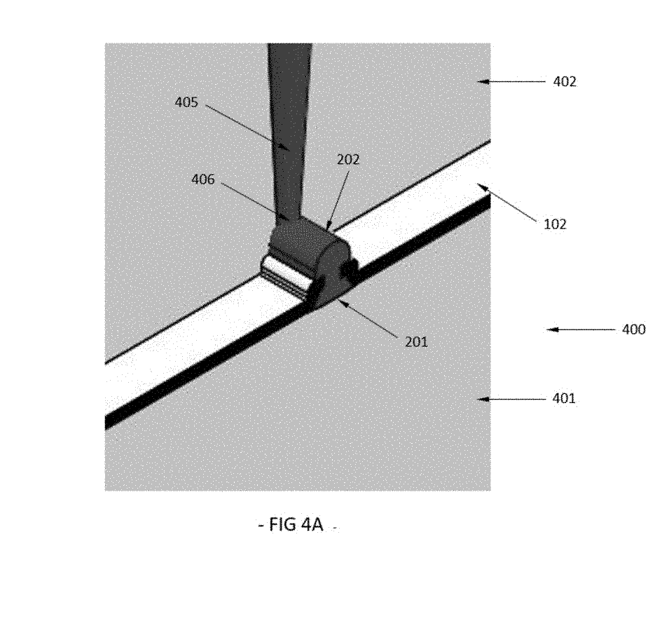

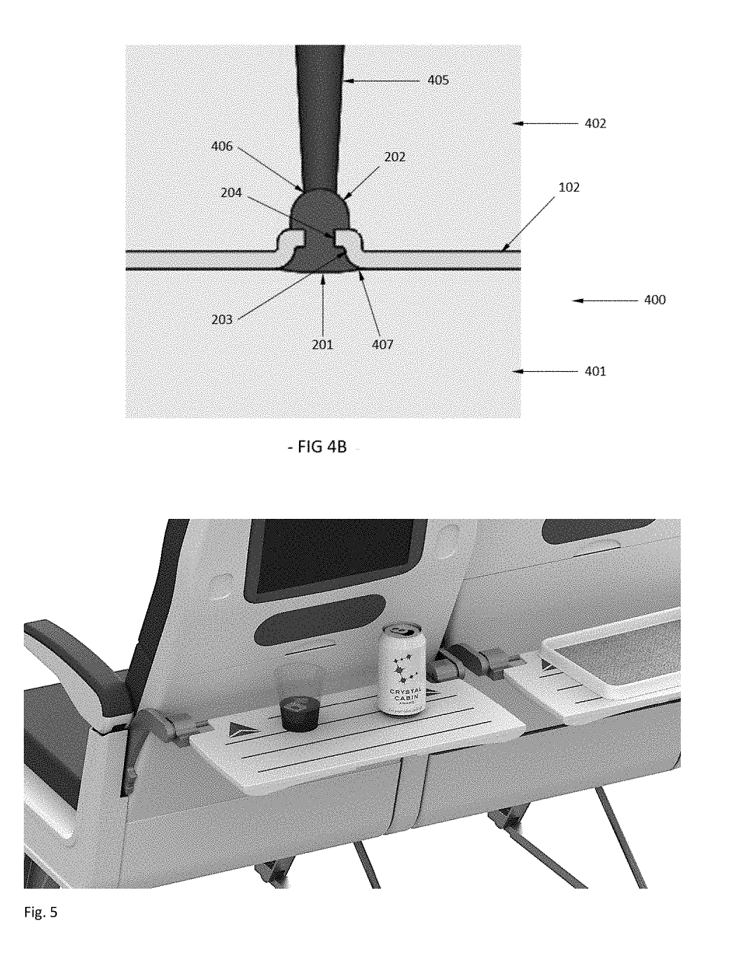

FIG. 4 is a cut-away perspective view of a tray table top cover friction device injection mold in one embodiment. FIG. 4 shows but one injection mold and is shown for illustrative purposes only. The cavity detail 401 and core detail 402 are shown. The injection mold sprue 403 and the runner system 404 show how material can be delivered to form the non-slip friction device 104 via the aperture 204 and runner system 202. FIG. 4 illustrates cavity sprue gates 405 and gate detail 400.

FIG. 4A is an enlarged cut-away perspective view detail of a tray table top cover friction device injection mold in one embodiment. As noted, FIG. 4A shows the cavity sprue gate 405, and the gate to compliant friction device interface 406.

FIG. 4B is an enlarged cut-away side view of detail of a tray table top cover integral compliant friction device injection mold in one embodiment.

FIG. 5 is a perspective view of a tray table in a down position in one embodiment. The tray table can comprise a single or bi-fold tray table. The tray table, in one embodiment, is hingedly connected to a seat so that it can be stored or pulled in the down position to house items. Depicted in FIG. 5 is the cup and beverage container frequently given by airline operators. Even if a cup holder is provided, the cup holder only maintains one of the two items. A passenger is required to hold, secure, or otherwise ensure the additional container does not slide, often resulting in spills as described above. The non-slip device 104 eliminates this problem as well as a need for a dedicated cup holder.

In one embodiment the non-slip device 104 can utilize microbial additives to ensure the passenger will not contacted unwanted bacterial during use of the tray. In another embodiment the non-slip device 104 comprises chemical resistant materials. Further, non-slip device 104 can comprise FAA 25.853 compliant materials to meet flammability, smoke and toxicity emissions, and heat release per OSU 55/55 when required.

While the non-slip device 104 has been described in reference to a top cover 102, this is for illustrative purposes only and should not be deemed limiting As but one example, often in bi-fold tray applications, the tray table rotates out of its back-of-seat stowed position but not rotate the front leaf from the back connected leaf. This results in a half-tray. Accordingly, some tray tables include an integral cup recess in the bottom cover. In such embodiments the bottom cover 103 will comprise a non-slip device 104. Thus, in some embodiments the non-slip device 104 is located on the top cover 102 and/or the bottom cover 103.

As noted above, the non-slip device prevents an item from slipping or sliding from a substantially planar surface. While the use in a tray table has been discussed, this is for illustrative purposes only. The non-slip device can similarly be used in desks, nightstands, laptop tables, etc. Many of the same non-slip advantages can be realized in other substantially planar applications.

As noted, the shape and location of the non-slip device can vary depending upon application. As noted, in a tray table, the non-slip can be located where passengers typically store their drink, such as the upper corners. For a desk, the non-slip can be located in the middle to help prevent books and other items from falling downward. The amount of non-slip relative to the planar surface will vary upon application. For some applications the non-slip will take up less than 10% of the total surface area on the top surface. In other embodiments, the non-slip will comprise less than 50% of the total surface area on the top surface.

One embodiment has been described wherein the top surface is planar. However, this is for illustrative purposes only.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
Clause 1. A surface comprising:
   a top cover;
   wherein said top cover comprises a recess and at least one aperture which extends completely through said top cover;
   a non-slip device coupled to said recess and said aperture.
Clause 2. The surface of any proceeding or preceding claim wherein said non-slip comprises an exposed side above said top cover, and a hidden side below said top cover.
Clause 3. The surface of any proceeding or preceding claim wherein said hidden side comprises a runner system, and wherein said runner system fluidly connects each aperture.
Clause 4. The surface of any proceeding or preceding claim wherein said exposed side comprises an inverted V-shape.
Clause 5. The surface of any proceeding or preceding claim wherein said exposed side comprises a raised portion.
Clause 6. The surface of any proceeding or preceding claim wherein said raised portion extends between about 0.001 and 0.005 inches above said top cover.
Clause 7. The surface of any proceeding or preceding claim wherein said non-slip device comprises a flexible thermoplastic material.
Clause 8. A tray table comprising:
   a top cover coupled to a bottom cover;
   wherein said top cover comprises a recess and at least one aperture which extends completely through said top cover;
   a non-slip device coupled to said recess.
Clause 9. The tray table of any proceeding or preceding claim wherein said recess extends for a length, and wherein said non-slip device extends for the same length.
Clause 10. The tray table of any proceeding or preceding claim wherein said non-slip device comprises an exposed side above said top cover and a hidden side below said top cover.
Clause 11. The tray table of any proceeding or preceding claim wherein said hidden side comprises a runner system, and wherein said runner system fluidly connects each aperture.
Clause 12. The tray table of any proceeding or preceding claim wherein said hidden side and said exposed side each comprise a volume, and wherein said hidden side is greater than 50% by volume than said exposed side.
Clause 13. The table of any proceeding or preceding claim wherein said exposed side comprises an inverted V-shape.
Clause 14. The table of any proceeding or preceding claim wherein said exposed side comprises a raised portion.
Clause 15. The table of any proceeding or preceding claim wherein said raised portion extends between about 0.001 and 0.005 inches above said top cover.
Clause 16. The tray table of any proceeding or preceding claim wherein said recess has a depth between about 0.03 and 0.07 inches.
Clause 17. The tray table of any proceeding or preceding claim wherein said recess and said non-slip device comprises a linear shape.
Clause 18. The tray table of any proceeding or preceding claim wherein said non-slip device comprises a flexible thermoplastic material.
Clause 19. The tray table of any proceeding or preceding claim wherein said recess has a depth of between about 0.03 and 0.07 inches, and wherein non-slip device comprises a flexible thermoplastic material, and wherein said top cover comprises at least two apertures, and wherein hidden side comprises a runner system, and wherein said runner system fluidly connects each aperture, and wherein said exposed side comprises a raised portion extends between about 0.001 and 0.005 inches above said top cover, and wherein said exposed side comprises an inverted V-shape, and wherein said exposed portion comprises a width, and wherein said recess comprises a width, and wherein the width of the exposed portion is greater than the width of the recess.

What is claimed is:

1. A surface comprising:
a top cover;
wherein said top cover comprises a recess and at least one aperture which extends completely through said top cover;
a non-slip device coupled to said recess and said aperture.

2. The surface of claim 1 wherein said non-slip comprises an exposed side above said top cover, and a hidden side below said top cover.

3. The surface of claim 2 wherein said hidden side comprises a runner system, and wherein said runner system fluidly connects each aperture.

4. The surface of claim 2 wherein said exposed side comprises an inverted V-shape.

5. The surface of claim 2 wherein said exposed side comprises a raised portion.

6. The surface of claim 5 wherein said raised portion extends between about 0.001 and 0.005 inches above said top cover.

7. The surface of claim 5 wherein said non-slip device comprises a flexible thermoplastic material.

8. A tray table comprising:
a top cover coupled to a bottom cover;
wherein said top cover comprises a recess and at least one aperture which extends completely through said top cover;
a non-slip device coupled to said recess.

9. The tray table of claim 8 wherein said recess extends for a length, and wherein said non-slip device extends for the same length.

10. The tray table of claim 8 wherein said non-slip device comprises an exposed side above said top cover and a hidden side below said top cover.

11. The tray table of claim 10 wherein said hidden side comprises a runner system, and wherein said runner system fluidly connects each aperture.

12. The tray table of claim 10 wherein said hidden side and said exposed side each comprise a volume, and wherein said hidden side is greater than 50% by volume than said exposed side.

13. The table of claim 10 wherein said exposed side comprises an inverted V-shape.

14. The table of claim 10 wherein said exposed side comprises a raised portion.

15. The table of claim 14 wherein said raised portion extends between about 0.001 and 0.005 inches above said top cover.

16. The tray table of claim 8 wherein said recess has a depth between about 0.03 and 0.07 inches.

17. The tray table of claim 8 wherein said recess and said non-slip device comprises a linear shape.

18. The tray table of claim 8 wherein said non-slip device comprises a flexible thermoplastic material.

19. The tray table of claim 8 wherein said recess has a depth of between about 0.03 and 0.07 inches, and wherein non-slip device comprises a flexible thermoplastic material, and wherein said top cover comprises at least two apertures, and wherein hidden side comprises a runner system, and wherein said runner system fluidly connects each aperture, and wherein said exposed side comprises a raised portion extends between about 0.001 and 0.005 inches above said top cover, and wherein said exposed side comprises an inverted V-shape, and wherein said exposed portion comprises a width, and wherein said recess comprises a width, and wherein the width of the exposed portion is greater than the width of the recess.
